(19) United States
(12) Patent Application Publication
(10) Pub. No.: US 2026/0094034 A1
(43) Pub. Date: Apr. 2, 2026

(54) SYSTEMS AND METHODS FOR SAMPLING-BASED KRYLOV QUANTUM DIAGONALIZATION

(71) Applicant: International Business Machines Corporation, Armonk, NY (US)

(72) Inventors: Kunal Sharma, White Plains, NY (US); Minh Tran, Cambridge, MA (US); Javier Robledo Moreno, New York, NY (US); Antonio Mezzacapo, Brooklyn, NY (US); William Kirby, Cambridge, MA (US); Petar Jurcevic, New York, NY (US); Jeffery Yu, Great Falls, VA (US); Joseph Iosue, Rockville, MD (US)

(21) Appl. No.: 18/889,494

(22) Filed: Sep. 19, 2024

(51) Int. Cl. G06N 10/20

(52) U.S. Cl. CPC G06N 10/20

(57) ABSTRACT

A system includes a processor that executes computer executable components stored in a memory. The computer executable components can comprise can comprise a reference component that selects reference state and applies time evolution with respect to a Hamiltonian for different times to prepare Krylov basis states on a quantum device; a base component that prepares the Krylov basis states to obtain a fixed number of samples by sampling from the prepared basis states to classically represent the original Hamiltonian; and a representation component that classically represents the original Hamiltonian in subspace generated by the fixed number of samples to diagonalize the Hamiltonian in a bitstring subspace to obtain an approximation of ground state energy of the original Hamiltonian.

### TECHNICAL FIELD

The subject disclosure relates to approximating ground state energy of many-body systems, e.g., sampling-based Krylov quantum diagonalization.

### BACKGROUND

Approximating the ground state energy of many-body systems is fundamental for various applications. However, phase-estimation-based methods are out of reach for near-term quantum devices due to their high circuit-depth requirements. Two alternative ground state energy estimation algorithms have recently been introduced that are more feasible for pre-fault-tolerant quantum computers, one based on sampling, and the other based on diagonalizing in a Krylov space.

Quantum devices have shown promising progress, yet their capabilities remain largely limited to specific tasks such as simulation of Hamiltonian time-evolutions. A significant bottleneck for many practical applications is the efficient estimation of the low-energy spectrum of quantum systems. Existing methods such as phase estimation often require deep quantum circuits and variational approaches require parametric optimization, preventing them from scaling to large problem instances. Thus, new algorithms are needed for efficiently estimating the spectral properties of physical systems on current quantum hardware.

Quantum subspace diagonalization methods have emerged as promising algorithms for estimating spectral properties on pre-fault-tolerant devices. Notably, the Krylov Quantum Diagonalization (KQD) method has recently been experimentally demonstrated for quantum many-body systems of up to 56 spins. KQD involves constructing a subspace by time-evolving a reference state over various time intervals, then classically diagonalizing the Hamiltonian within the corresponding subspace. An advantage of this approach is that it possesses analytic error bounds even in the presence of noise on the quantum device.

Another subspace algorithm is Sample-Based Quantum Diagonalization (SQD), which approximates ground state energies by sampling from a quantum state and performing sophisticated classical post-processing using quantum-centric supercomputing. Unlike KQD, SQD does not require time-evolution circuits, making it feasible in near-term for Hamiltonians with a large number of terms. SQD has recently been experimentally demonstrated for chemistry Hamiltonians.

While KQD and SQD have both been experimentally demonstrated, achieving the state-of-art for their respective applications, each method presents unique challenges. KQD requires estimating the projected Hamiltonian and overlap matrix associated with the Krylov subspace, and performing error mitigation on the corresponding observables poses experimental difficulties. In contrast, SQD relies on obtaining a good ansatz for the ground state to sample the relevant bitstrings efficiently, and also requires the ground state to be sparse.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate approximating ground state energy of many-body systems are provided.

According to an embodiment, a system can comprise a processor that executes computer executable components stored in memory. The computer executable components can comprise a reference component that selects reference state and applies time evolution with respect to a Hamiltonian for different times to prepare Krylov basis states on a quantum device; a base component that prepares the Krylov basis states to obtain a fixed number of samples by sampling from the prepared basis states to classically represent the original Hamiltonian; and a representation component that classically represents the original Hamiltonian in subspace generated by the fixed number of samples to diagonalize the Hamiltonian in a bitstring subspace to obtain an approximation of ground state energy of the original Hamiltonian.

An advantage of this system is that it outperforms traditional Krylov quantum diagonalization in the presence of shot noise, making it well-suited for near-term quantum devices.

According to another embodiment, a computer-implemented method can comprise selecting, by a system operatively coupled to a processor, a reference state and applying time evolution with respect to a Hamiltonian for different times to prepare Krylov basis states on a quantum device. The computer-implemented method further comprises preparing, by the system, the Krylov basis states on the quantum device to obtain a fixed number of samples by sampling from the prepared basis states in order to classically represent the original Hamiltonian. The computer implemented method can further comprise classically representing, by the system, the original Hamiltonian in subspace generated by the fixed number of samples to diagonalize the Hamiltonian in a bitstring subspace to obtain an approximation of ground state energy of the original Hamiltonian.

An advantage of this computer-implemented method is that it outperforms traditional Krylov quantum diagonalization in the presence of shot noise, making it well-suited for near-term quantum devices.

According to another embodiment, a computer program product comprising a computer readable storage medium having program instructions embodied therewith, the program instructions executable by a processor to cause the processor to select, by the processor, a reference state and apply time evolution with respect to the Hamiltonian for different times in order to prepare Krylov basis states on a quantum device. The program instructions can also cause the processor to prepare, by the processor, the Krylov basis states on the quantum device to obtain a fixed number of samples by sampling from the prepared basis states to classically represent the original Hamiltonian. The program instructions can further cause the processor to classically represent, by the processor, the original Hamiltonian in subspace generated by the samples to diagonalize the Hamiltonian in a bitstring subspace to obtain an approximation of ground state energy of the original Hamiltonian.

### DESCRIPTION OF THE DRAWINGS

FIG. 1 illustrates block diagram of an example, non-limiting system that can facilitate approximating ground state energy of many-body systems, e.g., sampling-based Krylov quantum diagonalization.

FIG. 2 illustrates block diagram of an example, non-limiting ground state energy approximation flow diagram in accordance with one or more embodiments described herein.

FIG. 3 illustrates an example, non-limiting comparison of SKQD and SQD methods in accordance with one or more embodiments described herein.

FIG. 4 illustrates a block diagram of an example, non-limiting, cloud computing environment in accordance with one or more embodiments described herein.

FIG. 5 illustrates a block diagram of example, non-limiting, abstraction model layers in accordance with one or more embodiments described herein.

FIG. 6 illustrates a block diagram of an example computing environment in which one or more embodiments described herein can be facilitated.

Appendix A is a paper entitled Sampling-based Krylov Quantum Diagonalization, and this paper forms part of this specification.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

To address challenges of KQD and SQD noted above, a new algorithm is introduced that leverages strengths of both KQD and SQD. Specifically, after preparing Krylov basis states on a quantum device, systems and methods introduced herein sample from these states in computational basis and then diagonalize Hamiltonian in bitstring subspace. This approach is referred to herein as Sampling-based Krylov Quantum Diagonalization (SKQD).

It is proven herein that if true ground state is sparse, SKQD can approximate ground state energy with high accuracy, with additive error depending on sparsity. Moreover, the number of experiments required to successfully sample all relevant bitstrings is inversely proportional to overlap between initial reference state and the true ground state.

In numerical experiments for a perturbed transverse field Ising model, it is found that SKQD outperforms KQD in presence of shot noise. This makes SKQD particularly promising for estimating spectral properties of many-body Hamiltonians on current quantum hardware. Identifying physical systems whose ground states exhibit sparsity is an important direction for practical applications in near term.

Description herein briefly turns to a discussion of Krylov quantum diagonalization (KQD). Let H denote the Hamiltonian in a system of n qubits, acting on an N=2ⁿ-dimensional Hilbert space. Discussion herein pertains to approximating ground state energy of H. Let |ψ₀ [symbol] denote initial (reference) state. Quantum Krylov subspace [symbol] is generated by time-evolved states

$$\vert {Ψ}_{k} 〉 := {e}^{ikH Δ t} \vert {Ψ}_{0} 〉 \qquad ( 1 )$$

where k∈{−d, −d+1, . . . , d} and Δt is a chosen time step. This construction reduces exponentially large N-dimensional Hilbert space to a subspace of dimension D=2d+1. By projecting the Hamiltonian onto [symbol] , the following generalized eigenvalue problem is obtained:

$$\tilde{H} \vert ψ 〉 = \tilde{E} \tilde{S} \vert ψ 〉 , \qquad ( 2 )$$

over ψ∈ [symbol] , where:

$${\tilde{H}}_{jk} = 〈 {Ψ}_{j} \vert H \vert {Ψ}_{k} 〉 , {\tilde{S}}_{jk} = 〈 {Ψ}_{j} \vert {Ψ}_{k} 〉 . \qquad ( 3 )$$

Let E₀≤E₁≤ . . . ≤E_{N-1} denote eigenvalues of H with corresponding orthonormal eigenstates |ψ₀ [symbol] , . . . , |ψ_{N-1} [symbol] . Let ΔEⱼ=Eⱼ−E₀ for each 0<j<N and let

$$\vert {Ψ}_{0} 〉 = {\sum }_{k = 0}^{N - 1} {γ}_{k} \vert {ψ}_{k} 〉$$

be the eigenstate decomposition of the initial state. Let \tilde{E} denote the ground state energy approximation obtained from the Krylov quantum subspace approach. From the results of Epperly et al., it follows that in the ideal, noise-free case, 0≤\tilde{E}−E≤ε, for

$$ε = 8 Δ {E}_{N - 1} ( \frac{1 - {\vert {γ}_{0} \vert}^{2}}{{\vert {γ}_{0} \vert}^{2}} ) {( 1 + \frac{πΔ {E}_{1}}{Δ {E}_{N - 1}} )}^{- ( D - 1 )} , \qquad ( 4 )$$

where |γ₀|² denotes overlap of initial state Ψ₀ with true ground state |ψ₀ [symbol] . This assumes that the timestep in Equation (1) is chosen as Δt=π/ΔE_{N-1}. If the initial state has a nontrivial ground state overlap, and if H has a well-behaved spectrum, then a constant error ε as in Equation (4) in approximating ground state energy can be achieved by setting D=O(log(1/ε)).

The description herein briefly turns to a discussion of sampling-based quantum diagonalization (SQD). Suppose that ground state of H is sparse in computational basis. Sparsity is defined as follows. Fix an ordering of bitstrings b₁, . . . , b_{N} such that their amplitudes in ground state of H have decreasing magnitude, i.e.,

$$\vert {ψ}_{0} 〉 = {\sum }_{j = 1}^{N} {c}_{j} \vert {b}_{j} 〉$$

with |c₁|≥|c₂|≥ . . . |c_{N}|. A state is defined such that

$$\vert ψ 〉 = {\sum }_{j = 1}^{N} {a}_{j} \vert {b}_{j} 〉$$

to be (α_{L}, β_{L})-concentrated on |b₁ [symbol] through |b_{L} [symbol] if

$${\sum }_{j = 1}^{L} {\vert {a}_{j} \vert}^{2} \geq {α}_{L}$$

and |a₁|², . . . , |a_{L}|²≥β_{L}. Suppose that true ground state is

$$( {α}_{L}^{( 0 )} , {β}_{L}^{( 0 )} )$$

-concentrated. If one can prepare a good approximation of ground state such that all L bitstrings (b₁, . . . , b_{L}) can be sampled with high probability, then H can be represented in subspace spanned by

$${\{ \vert {b}_{j} 〉 \}}_{j = 1}^{L} ,$$

yielding a projected matrix Ĥ. By classically diagonalizing Ĥ, an approximation of E₀ is obtained. Using this approach, one can approximate E₀ with an additive error of up to

$${ε}^{′} = 2 \sqrt{2} ‖ H ‖ {( 1 - \sqrt{{α}_{L}^{0}} )}^{1 / 2}$$

and a success probability of at least 1−η, provided that the number of samples obtained from the state exceeds

$$( 2 / {β}_{L}^{( 0 )} log ( 1 / η ) ) .$$

As discussed above, the KQD approach can achieve good accuracy in estimating ground state energy, provided initial state has a strong overlap with ψ₀ and the spectrum of H is well-behaved. However, this approach is challenging on near-term quantum devices because it requires estimating the matrix elements of \tilde{H} and \tilde{S}, necessitating O(1/ϵ²) samples to achieve error ϵ, and additional shots overhead for noise mitigation. On the other hand, the SQD approach is more straightforward for near-term devices, but is constrained to situations where the ground state is sparse and one can prepare a good approximation of it.

Embodiments detailed herein pertain to a near-term method for estimating ground state energies by combining KQD and SQD approaches. A central idea is to prepare Krylov basis states on a quantum device and obtain samples from them in computational basis. The Hamiltonian in the subspace spanned is then diagonalized by sampled bitstrings to approximate ground state energy of H.

Description herein briefly turns to a discussion of Sampling-based Krylov Quantum Diagonalization (SKQD). First, sparsity assumption for ground states-suppose ground state |ψ₀ [symbol] of H is

$$( {α}_{L}^{( 0 )} , {β}_{L}^{( 0 )} )$$

-concentrated. It is assumed that it is sparse in the sense that L=poly(n). Note that the definition of sparseness (or peakedness) herein differs from those in PROCEEDINGS OF THE 56 TH ANNUAL ACM SYMPOSIUM ON THEORY OF COMPUTING (2024), pages 561-572, Classical Simulation of Peaked Shallow Quantum Circuits by Sergey Bravyi, David Gosset, and Yinchen Liu, and On Verifiable Quantum Advantage With Peaked Circuit Sampling (2024) by Scott Aaronson and Yuxuan Zhang. In On Verifiable Quantum Advantage With Peaked Circuit Sampling, a unitary circuit C is defined as δ-peaked if there exists at least one bitstring s∈{0,1}ⁿ such that | [symbol] s|C|0 [symbol] |²>δ. The focus of On Verifiable Quantum Advantage With Peaked Circuit Sampling was on random peaked circuits and determining whether such circuits can be distinguished from fully random circuits in classical polynomial time. Similarly, Classical Simulation of Peaked Shallow Quantum Circuits defines a circuit family {Uₙ} as peaked if for some a∈ [symbol] _{≥0}, each Uₙ is δ-peaked for n≥0 with δ=n^{-a}. In this context, an n-qubit circuit is considered peaked if it has an output probability that is at least inverse-polynomial in n. In Classical Simulation of Peaked Shallow Quantum Circuits, the authors developed classical algorithms for sampling and estimating output probabilities of constant-depth peaked quantum circuits. In contrast, the definition of peakedness herein requires the weight to be concentrated on L bitstrings, rather than requiring at least one bitstring to have high probability.

For each k∈{−d, −d+1, . . . , d} in Equation 1, M=(n) copies of state |Ψₖ [symbol] are prepared and each in the computational basis is measured to obtain a sequence of bitstrings

$${\{ {a}_{km} \}}_{m = 1}^{M} .$$

H is then classically projected into subspace spanned by {aₖₘ} for all k and m, as in SQD, and the resulting matrix denoted as \tilde{H}. Finally, the eigenvalue problem is solved for \tilde{H}, which is of polynomial size and thus can be computed classically.

To ensure that the approach—sampling directly from the Krylov basis states—yields a good approximation of E₀ with high probability, several key results are proven. First, it is shown that if the KQD method achieves an additive error ε in the energy as in Equation (4), then the error in the corresponding approximate ground state |ψ [symbol] is

$$‖ \vert Ψ 〉 - \vert {ψ}_{0} 〉 ‖ \leq \tilde{ε} ∈ O ( \frac{ε}{Δε \text{?}} ) .$$

$$\text{?} \text{indicates text missing or illegible when filed}$$

Next, it is shown that if the true ground state |ψ₀ [symbol] is

$$( {α}_{L}^{( 0 )} , {β}_{L}^{( 0 )} )$$

-concentrated, then |ψ [symbol] is (α_{L}, β_{L})-concentrated, with

$${α}_{L} = {α}_{L}^{( 0 )} - 2 \sqrt{\text{?}} and {β}_{L} = {β}_{L}^{( 0 )} - 2 \sqrt{\text{?}} .$$

$$\text{?} \text{indicates text missing or illegible when filed}$$

The set of important bitstrings defining the ground state are denoted as

$${B = \{ \vert {b}_{i} 〉 \}}_{i = 1}^{L} ,$$

where a bitstring's importance is determined by |cᵢ|, as defined above. It is proven that each bitstring in B has sufficient overlap with at least one of the Krylov basis states. Given that

$$\vert Ψ 〉 = {\sum }_{k = - d}^{d} {d}_{k} \vert {Ψ}_{k} 〉 ,$$

where |ψₖ [symbol] is defined in Equation 1, and

$$\vert {d}_{k} \vert \leq \frac{1}{{γ}_{0}}$$

for each 1≤k≤D, each |ψₖ [symbol] is expressed in the computational basis as

$$\vert {Ψ}_{k} 〉 = {\sum }_{j = 1}^{N} {c}_{j}^{( k )} {b}_{j} .$$

It is then shown that for each 1≤j≤L, there exists some k such that

$${\vert {c}_{j}^{( k )} \vert}^{2} \geq p ,$$

with

$$p = \frac{{γ}_{0}^{2} {β}_{L}}{{D}^{2}} .$$

Thus, one can efficiently obtain the L important bitstrings by sampling from Krylov basis states, provided the initial state |ψ₀ [symbol] has a good overlap γ₀ with the true ground state.

Finally, combining these results, the following theorem is proven:
Theorem 1 Let H be a Hamiltonian whose ground state |ψ₀ [symbol] is

$$( {α}_{L}^{( 0 ) ,} , {β}_{L}^{( 0 )} ) -$$

concentrated. The error in estimating the ground state energy of H is bounded by

$$〈 \tilde{ψ} \vert H \vert \tilde{ψ} 〉 - 〈 {ψ}_{0} \vert H \vert {ψ}_{0} 〉 \leq \sqrt{8} ‖ H ‖ {( 1 - \sqrt{{α}_{L}^{( 0 )}} )}^{1 / 2}$$

provided all L important bitstrings are sampled. The success probability of sampling all L important bitstrings is at least 1−η as long as the number of samples from each Krylov basis state exceeds

$$( log ( L / η ) {D}^{2} ) / ( {γ}_{0}^{2} ( {β}_{L}^{( 0 )} - 2 \sqrt{\tilde{ε} )} ) , ,$$

where

$$\tilde{ε} = 2 - \sqrt[2]{1 - ε / Δ {E}_{1}} ,$$

with ε defined in Eq. (4).

Thus, the algorithm can approximate ground state energy of H accurately, as long as sparsity parameter

$${α}_{L}^{( 0 )}$$

is close to one. Additionally, success probability of sampling all L important bitstrings is inversely proportional to

$${γ}_{0}^{2} ,$$

a requirement similar to the KQD method, as discussed above.

Description herein briefly turns to a presentation of numerical simulations of the SKQD approach applied to a perturbed transverse field Ising model

$$H = - {\sum }_{j = 1}^{n - 1} {Z}_{j} {Z}_{j + 1} - {h}_{1} {\sum }_{j = 1}^{n} {X}_{j} - {h}_{2} {Z}_{1} . \qquad ( 5 )$$

When h₁=h₂=0, the ground states are spanned by the bitstrings |0ⁿ [symbol] and |1ⁿ [symbol] . A positive h₂ breaks the degeneracy in favor for |0ⁿ [symbol] . Below, for h₁=h and h₂=0, it is shown that if h=O((k/n)^{a}) for any a>½, then the ground state of Hₙ(h) is fully supported on O(n^{k}) bitstrings.

For numerical simulations, the initial state |χ₀ [symbol] =|0ⁿ). To ensure a fair comparison, add a Gaussian noise

$$𝒩 ( 0 , \frac{1}{\sqrt{M}} )$$

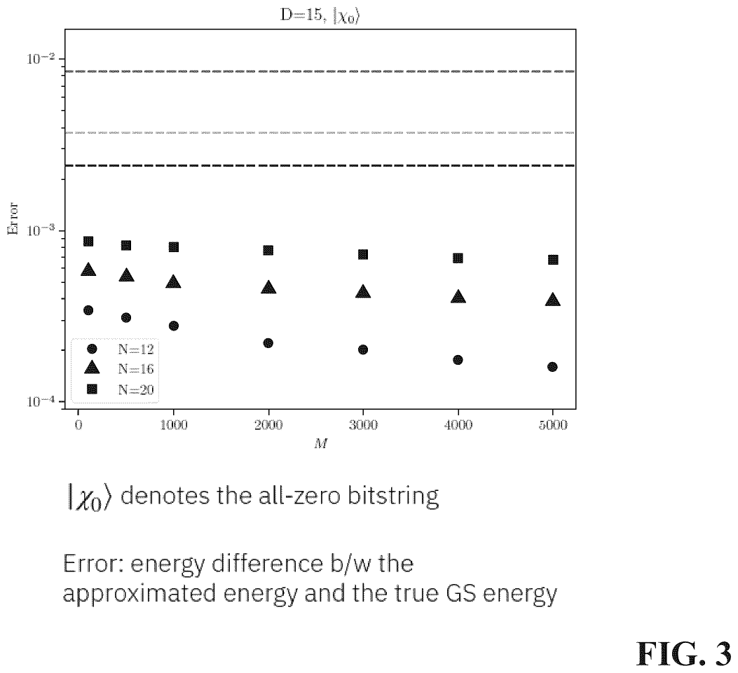

to each matrix element, as described in Equation (A3). Let h₁=h₂=0.1. Run the SKQD approach for D=15 different Kyrlov basis states and for varying numbers of samples from each basis state. Perform simulations with different numbers of qubits, as shown in FIG. 3. Set M=5000 to minimize shot noise in the KQD approach while computing each matrix element. Moreover, selected the best instance for the SKQD approach from 1000 trials. FIG. 3 demonstrates that SKQD outperforms the standard KQD approach across different numbers of qubits. The SKQD approach can outperform the standard KQD approach under the sparsity assumption on the ground states.

Description herein briefly turns to a discussion of a SKQD new algorithm for estimating ground state energy of Hamiltonians whose ground states are sparse in computational basis. Specifically, by sampling from Krylov basis states and diagonalizing the Hamiltonian within the bitstring subspace, it is proven and numerically verified that the ground state energy can be approximated with high accuracy. Additionally, the algorithm outperforms the standard KQD approach in the presence of shot noise. This makes the SKQD algorithm well-suited for near-term quantum devices, as it only requires Hamiltonian simulation circuits and sampling in the computational basis. This is also advantageous when an accurate approximation of the ground state is unavailable, as it only requires a state with a good overlap with the ground state, and the ansatz being replaced by Krylov basis states.

Description turns to a discussion of Krylov Quantum Diagonalization. Let [symbol] denote an N-dimensional Hilbert space, where N=2ⁿ and n denotes the number of qubits. Let H be a Hermitian operator on [symbol] with eigenvalues E₀≤E₁≤ . . . ≤E_{N-1} with corresponding orthonormal eigenstates |ψ₀ [symbol] , . . . , |ψ_{N-1} [symbol] . The goal is to estimate E₀. In general, the eigenvalue problem for an N-dimensional operator is computationally challenging, therefore approximate E₀ by considering the corresponding eigenvalue problem in a subspace. In particular, given some initial state Ψ₀, consider the subspace [symbol] spanned by

$$\vert {ψ}_{k} 〉 = {e}^{ikHΔ t} \vert {ψ}_{0} 〉 , k ∈ \{ - d , - d + 1 , - d + 2 , … , d \} , \qquad ( A1 )$$

for some chosen time step Δt and dimension D=2d+1. Then solve the following generalized eigenvalue problem

$$\tilde{H} \vert ψ 〉 = \tilde{E} \tilde{S} \vert ψ 〉 , \qquad ( A 2 )$$

for |ψ [symbol] ∈ [symbol] , where:

$${\tilde{H}}_{jk} = 〈 {Ψ}_{j} \vert H \vert {Ψ}_{k} 〉 , \qquad ( A3 )$$

$${\tilde{S}}_{jk} = 〈 {Ψ}_{j} \vert {Ψ}_{k} 〉 .$$

### Let

$$Δ {E}_{j} = {E}_{j} - {E}_{0} \qquad ( A4 )$$

for each 0<j<N and let

$$\vert {Ψ}_{0} 〉 = {\sum }_{k = 0}^{N - 1} {γ}_{k} \vert {ψ}_{k} 〉 \qquad ( A5 )$$

be the eigenstate decomposition of the initial state. For completeness, recall the accuracy of estimating the ground state energy using the Krylov quantum diagonalization approach from A theory of quantum subspace diagonalization by Ethan N. Epperly, Lin Lin, and Yuji Nakatsukasa in SIAM JOURNAL ON MATRIX ANALYSIS AND APPLICATIONS, 43 (3): 1263-1290 August 2022.
Theorem 1 Let

$$Δ t = \frac{π}{Δ {E}_{N - 1}}$$

and D denote the Krylov dimension as defined in Equation A1. Then the approximate ground state energy \tilde{E}₀ obtained from the method described in Eqs. (A1)-(A3) satisfies

$$0 \leq {\tilde{E}}_{0} - {\overline{E}}_{0} \leq δΔ {E}_{N - 1} ( \frac{1 - {\vert {γ}_{0} \vert}^{2}}{{\vert {γ}_{0} \vert}^{2}} ) {( 1 + \frac{πΔ {E}_{1}}{Δ {E}_{N - 1}} )}^{- ( D - 1 )} \qquad ( A6 )$$

where γ₀ denotes the coefficient of |ψ₀ [symbol] in Eq. (A5) and ΔEⱼ is defined in Eq. (A4). Note that the accuracy in approximating E₀ improves exponentially with the dimension D of the Krylov subspace. Moreover, the accuracy is inversely proportional to the overlap of the initial state with the ground state of H. A summary proof steps for Equation (A6) follows below. For any 0<a<π and positive integer d, there exists a trigonometric polynomial p* of degree d satisfying p*(0)=1 and

$$\vert \vert p * ( θ ) \vert \leq 2 {( 1 + a )}^{- d} ∀ θ ∈ ( - π , π ) \text{\textbackslash (} - a , a ) . \qquad ( A7 )$$

This polynomial is explicitly constructed as

$$p * ( θ ) = \frac{{T}_{k} ( 1 + 2 \frac{cos θ - cos α}{cos α + 1} )}{{T}_{k} ( 1 + 2 \frac{1 - cos α}{cos α + 1} )} , \qquad ( A8 )$$

where Tk is the kth-Chebyshev polynomial.
Let the Fourier expansion of p* be

$$p * ( ( E - {E}_{0} ) Δ t ) = {\sum }_{k = - d}^{d} {c}_{k} {e}^{ikEΔ t} . \qquad ( A9 )$$

Consider the following unnormalized state with variational parameters

$${\{ {c}_{k} \}}_{k = - d}^{d}$$

$$\vert Ψ 〉 = {\sum }_{k = - d}^{d} {c}_{k} \vert {Ψ}_{k} 〉 = {\sum }_{k = - d}^{d} {\sum }_{j = 0}^{N - 1} {c}_{k} {γ}_{j} {e}^{{ikE}_{j Δ t}} \vert {Ψ}_{j} 〉 . \qquad ( A10 )$$

The norm of |ψ [symbol] is given by

$${\vert 〈 Ψ \vert Ψ 〉 \vert}^{2} = {\sum }_{j = 0}^{N - 1} {\vert {γ}_{j} \vert}^{2} {\vert {\sum }_{k = - d}^{d} {c}_{k} {e}^{{ikE}_{j} Δ t} \vert}^{2} \geq {\vert {γ}_{0} \vert}^{2} {\vert {\sum }_{k = - d}^{d} {c}_{k} {e}^{{ikE}_{0} Δ t} \vert}^{2} = {\vert {γ}_{0} \vert}^{2} {\vert p * ( 0 ) \vert}^{2} = {\vert {γ}_{0} \vert}^{2} . \qquad ( A11 )$$

Then the energy of |ψ [symbol] is given by

$$\frac{〈 Ψ \vert H \vert Ψ 〉}{〈 Ψ \vert Ψ 〉} = \frac{{\sum }_{j = 0}^{N - 1} {E}_{j} {\vert {γ}_{i} \vert}^{2} {\vert {\sum }_{k = - d}^{d} {e}^{{ikE}_{j Δ t}} \vert}^{2}}{〈 Ψ \vert Ψ 〉} \geq \frac{{\sum }_{j = 0}^{N - 1} {E}_{j} {\vert {γ}_{i} \vert}^{2} {\vert p * ( ( {E}_{j} - {E}_{0} ) Δ t ) \vert}^{2}}{{\vert {γ}_{0} \vert}^{2}} . \qquad ( A12 )$$

Applying (A7) with

$$a = ( {E}_{1} - {E}_{0} ) Δ t = \frac{π Δ {E}_{1}}{Δ {E}_{N - 1}}$$

gives

$$p * ( ( {E}_{j} - {E}_{0} ) Δ t ) \leq 2 {( 1 + \frac{πΔ {E}_{1}}{Δ {E}_{N - 1}} )}^{- d} \qquad ( A13 )$$

for each 1≤j≤N−1. The j=0 term cancels upon taking the difference with E₀ for the energy error.

Thus, for an initial state with a nontrivial ground state overlap |γ₀|=Θ(1) and for a Hamiltonian H that has a well-behaved spectrum, (i.e., ΔE_{N-1} not growing too quickly and ΔE₁ not too small), a constant error \tilde{E}₀−E₀≤can be achieved by taking d=O(log (1/)).

Description turns to a discussion of Krylov Diagonalization via Quantum Unitary Sampling and, more specifically, prove the performance guarantees for the Krylov diagonalization via quantum unitary sampling approach. As discussed above, prepare D different states on a quantum computer and collect M samples from each of them by measuring in the computational basis. In particular, let |Ψ₀ [symbol] denote the initial reference state. Then get M samples from each Krylov basis states |Ψₖ [symbol] as defined in Eq. (A1) for D=2d+1. In particular, get a sequence of bitstrings

$${\{ {a}_{k m} \}}_{k = 1}^{M}$$

for each k. Finally, solve the eigenvalue problem in the subspace spanned by {aₖₘ}, for k∈{1, . . . , D} and m∈{1, . . . , M}. Analyze the algorithm as follows. As in Chemistry Beyond Exact Solutions on a Quantum-Centric Supercomputer in ARXIV PREPRINT, ARXIV: 2405.05068, 2024., define sparseness in terms of concentration of the amplitudes in the computational basis. Fix an ordering of bitstrings b₁, . . . , b_{N} such that the ground state's amplitudes have decreasing magnitude:

$$\vert {ψ}_{0} 〉 = {\sum }_{j = 1}^{N} {c}_{j} \vert {b}_{j} 〉 , \vert {c}_{1} \vert \geq \vert {c}_{2} \vert \geq … \geq \vert {c}_{N} \vert . \qquad ( B1 )$$

Definition 1

$$A state \vert ψ 〉 = {\sum }_{j = 1}^{N} {a}_{j} \vert {b}_{j} 〉 is ( {α}_{L} , {β}_{L} ) - connected on \vert {b}_{1} 〉 through \vert {b}_{L} 〉 \qquad ( B2 )$$

$$if {\sum }_{j = 1}^{L} {\vert {a}_{j} \vert}^{2} \geq {α}_{L} {\vert {a}_{1} \vert}^{2} , … , {\vert {a}_{L} \vert}^{2} \geq {β}_{L} ,$$

where the basis expansion of |ψ [symbol] uses the same ordering for |b₁ [symbol] , . . . , |b_{N} [symbol] as fixed from Eq. (B1). Since |aᵢ|²≥β_{L}, ∀i, it implies that α_{L}≥Lβ_{L}, but α_{L} may be much larger in general. Here, separate the two as α_{L} will govern the rate of convergence for successful runs while β_{L} will govern the probability of success.

Below, the main theorem is restated and proven using several lemmas.
Theorem 2 Let H denote a Hamiltonian and (to) be the corresponding ground state as in Eq. (B1). Suppose the ground state |ψ₀ [symbol] is

$$( {α}_{L}^{( 0 )} , {β}_{L}^{( 0 )} )$$

concentrated. If the aforementioned algorithm succeeds in sampling L bitstrings, then the error in estimating the ground state energy of H is bounded by

$$〈 \tilde{ψ} \vert H \vert \tilde{ψ} 〉 - 〈 {ψ}_{0} \vert H \vert {ψ}_{0} 〉 \leq 2 \sqrt{2} ‖ H ‖ {( 1 - \sqrt{{α}_{L}^{( 0 )}} )}^{1 / 2} . \qquad ( B3 )$$

$$Let ε = 8 Δ {E}_{N - 1} ( \frac{1 - {\vert {γ}_{0} \vert}^{2}}{{\vert {γ}_{0} \vert}^{2}} ) {( 1 + \frac{πΔ {E}_{1}}{Δ {E}_{N - 1}} )}^{- ( D - 1 )} .$$

$$Then the probability of failing to sample all L bitstrings is$$

$${p}_{fail} \leq L exp ( - \frac{M {γ}_{0}^{2}}{{( 2 d + 1 )}^{2}} ( {β}_{L}^{( 0 )} - 2 \sqrt{2 - \sqrt{1 - ε}} ) ) . \qquad ( B4 )$$

As discussed above, choose d (equivalently D=2d+1) according to (A6) so that the error for the Krylov quantum diagonalization approach is bounded by. If we were to run the Krylov method on the {|Ψₖ|}, we would obtain a state [symbol] ∈ [symbol] with

$$〈 \tilde{ψ} \vert H \vert \tilde{ψ} 〉 - 〈 {ψ}_{0} \vert H \vert {ψ}_{0} 〉 = {\tilde{E}}_{0} - {E}_{0} < ε . \qquad ( B5 )$$

By the proof of Theorem 1, there exists some |Ψ [symbol] ∈ [symbol] satisfying (11) (but is not necessarily the ground state in [symbol] ) which also satisfies the following inequality:

$$\vert Ψ 〉 = {\sum }_{k = - d}^{d} {d}_{k} \vert {Ψ}_{k} 〉 \vert {d}_{k} \vert \leq \frac{1}{{γ}_{0}} , \qquad ( B6 )$$

which follows from Eq. (A11).

Note that to prove Eq. (B5), it is not necessary to solve the generalized eigenvalue problem to obtain [symbol] , so instead the analysis is on Ψ due to its additional structure as in Eq. (B6).

In Lemma 1, it is proven that a state that has a low-energy error with respect to the ground state energy, is also close to the ground state in 2-norm distance. It is then shown in Lemma 2 that a state close to a concentrated state is also concentrated.

Lemma 1 (A state with low energy is close to the ground state). Let H be a Hamiltonian with ground state
|ψ₀ [symbol] and spectral gap ΔE₁. If |Ψ [symbol] is a state such that [symbol] Ψ|H|Ψ [symbol] − [symbol] ψ₀|H|ψ₀ [symbol] < ε, then
$‖ \vert ψ 〉 - \vert {ψ}_{0} 〉 ‖ < 2 ( 1 - \sqrt{1 - \frac{ε}{Δ {E}_{1}}} ) = O ( \frac{ε}{Δ {E}_{1}} ) \qquad ( B7 )$
Proof. Let |Ψ [symbol] = γ₀|ψ₀ [symbol] + γ′|ψ′ [symbol] , where |ψ′ [symbol] is normalized and orthogonal to |ψ₀ [symbol] , such that |γ₀|² +|γ′|² = 1.
We can write [symbol] Ψ|H|Ψ [symbol] − [symbol] ψ₀|H|ψ₀ [symbol] < ε as
$\begin{matrix}\text{?} > {\vert {γ}_{0} \vert}^{2} {E}_{0} + {\vert {γ}^{′} \vert}^{2} 〈 {ψ}^{′} \vert H \vert {ψ}^{′} 〉 - {E}_{0} = ( {\vert {γ}_{0} \vert}^{2} - 1 ) {E}_{0} + ( 1 - {\vert {γ}_{0} \vert}^{2} ) 〈 {ψ}^{′} \vert ℋ \vert {ψ}^{′} 〉 \\ \geq ( 1 - {\vert {γ}_{0} \vert}^{2} ) Δ {E}_{1} . ( B 9 )\end{matrix} \qquad ( B8 )$
$Thus {\vert {γ}_{0} \vert}^{2} > 1 - \frac{\text{?}}{Δ E \text{?}} , giving$
$‖ \vert ψ 〉 - \vert {ψ}_{0} 〉 ‖ = {\vert {γ}_{0} - 1 \vert}^{2} + {\vert {γ}^{′} \vert}^{2} = 2 - 2 Re ( {γ}_{0} ) \geq 2 - 2 \vert {γ}_{0} \vert < 2 - 2 \sqrt{1 - \frac{\text{?}}{Δ {E}_{1}}} . \qquad ( B10 )$
$Expanding to the first order in \frac{\text{?}}{Δ {E}_{1}} gives an error bound of \frac{\text{?}}{Δ {E}_{1}} + O ( {\text{?}}^{2} ) .$
$\text{?} \text{indicates text missing or illegible when filed}$

$Lemma 2 ( A state close to a concentrated state remains concentrated ) . If \vert {ψ}_{0} 〉 is ( {α}_{L}^{( 0 )} , {β}_{L}^{( 0 )} ) - concentrated$
and |||Ψ [symbol] - |ψ₀ [symbol] || < ε, then |Ψ [symbol] is (α_{L}, β_{L})-concentrated for
${α}_{L} = {α}_{L}^{( 0 )} - 2 \sqrt{ε} {β}_{L} = {β}_{L}^{( 0 )} - 2 \sqrt{ε} . \qquad ( B11 )$
$Proof . Expand \vert Ψ 〉 in the computational basis as \vert Ψ 〉 = {\sum }_{j = 1}^{N} α \text{?} \vert {b}_{j} 〉 . Then$
$\begin{matrix}{\sum }_{j = 1}^{L} {\vert {a}_{j} \vert}^{2} = {\sum }_{j = 1}^{L} {\vert {c}_{j} + ( {a}_{j} - {c}_{j} ) \vert}^{2} = {\sum }_{j = 1}^{L} {\vert {c}_{j} \vert}^{2} + {\sum }_{j = 1}^{L} {\vert {a}_{j} - {c}_{j} \vert}^{2} + 2 {\sum }_{j = 1}^{L} Re ( {c}_{j} ( {a}_{j} - {c}_{j} ) ) & ( B12 ) \\ \geq {a}_{L}^{( 0 )} + 0 - 2 {\sum }_{j = 1}^{L} \vert {c}_{j} \vert \vert {a}_{j} - {c}_{j} \vert & ( B13 ) \\ \geq {α}_{L}^{( 0 )} - 2 \sqrt{{\sum }_{j} {\vert {c}_{j} \vert}^{2} {\sum }_{k} {\vert {a}_{k} - {c}_{k} \vert}^{2}} & ( B14 ) \\ \geq {α}_{L}^{( 0 )} - 2 \sqrt{ε} , & ( B15 )\end{matrix}$
$showing that we may take {α}_{L} = {α}_{L}^{( 0 )} - 2 \sqrt{ε} . Here , in the third equality we replaced {\sum }_{j = 1}^{L} {\vert {c}_{j} \vert}^{2} \leq 1 and used$
the fact that |||Ψ [symbol] − |ψ₀ [symbol] || < ε implies Σₖ |aₖ − cₖ| ≤ ε
We now prove a similar condition for β_{L}. Since |||Ψ [symbol] − |ψ₀ [symbol] || < ε. we must have |aⱼ − cⱼ| < \sqrt{ε} for each
1 ≤ j ≤ N. Then for each 1 ≤ j ≤ L, we have
$\begin{matrix}{\vert {a}_{j} \vert}^{2} = {\vert {c}_{j} + ( {a}_{j} - {c}_{j} ) \vert}^{2} = {\vert {c}_{j} \vert}^{2} + {\vert {a}_{j} - {c}_{j} \vert}^{2} + 2 Re ( {c}_{j} ( {a}_{j} - {c}_{j} ) ) \\ \geq {β}_{L}^{( 0 )} + 0 - 2 \vert {c}_{j} \vert \vert {a}_{j} - {c}_{j} \vert ( B 17 ) \\ \geq {β}_{L}^{( 0 )} - 2 \sqrt{ε} . ( B 18 )\end{matrix} \qquad ( B16 )$
$\text{?} \text{indicates text missing or illegible when filed}$

Thus one may take

$${β}_{L} = {β}_{L}^{( 0 )} - 2 \sqrt{ε} .$$

It was shown in Lemma 2 that if the Krylov quantum diagonalization (KQD) approach has ε guarantee and if the true ground state is

$$( {α}_{L}^{( 0 )} , {β}_{L}^{( 0 )} )$$

-concentrated, then a solution to the KQD approach is also (α_{L}, β_{L}) concentrated. Using this result, we know it is now proven that with a high probability, each concentrated bitstring corresponding to the ground state |ψ₀ [symbol] appears nontrivially in at least one of the Krylov basis states. This is crucial for establishing a bound on the error corresponding the Krylov diagonalization via quantum unitary sampling approach.

### Lemma 3 (Each Concentrated Bitstring Appears Nontrivially in at Least One Basis State).

Let |Ψ [symbol] is (α_{L},β_{L})-concentrated as in Definition 1 and

$$\vert Ψ 〉 = {\sum }_{k = - d}^{d} {d}_{k} \vert {Ψ}_{k} 〉$$

as in Equation A1. If each |Ψₖ| is represented in the computational basis as

$$\vert {Ψ}_{k} 〉 = {\sum }_{j = 1}^{N} {c}_{j}^{( k )} \vert {b}_{j} 〉 and \vert {d}_{k} \vert \leq \frac{1}{{γ}_{0}}$$

for each 1≤k≤D, then for each 1≤j≤L there exists some

$${c}_{j}^{( k )}$$

such that

$$\vert {c}_{j}^{{( k )}^{2}} \vert \geq p$$

with

$$p = \frac{{γ}_{0}^{2} {β}_{L}}{{D}^{2}} . \qquad ( B19 )$$

Here, D=2d+1 and γ₀ denotes the overlap of |ψ₀ [symbol] with the ground state, as defined in Eq. (A1).

Proof. For each 1≤j≤L,

$${\sum }_{k = - d}^{d} \vert {c}_{j}^{( k )} \vert \geq {\sum }_{k = - d}^{d} {γ}_{0} \vert {d}_{k} \vert \vert {c}_{j}^{( k )} \vert \geq {γ}_{0} \vert {\sum }_{k = - d}^{d} {d}_{k} {c}_{j}^{( k )} \vert = {γ}_{0} \vert {a}_{j} \vert \geq {γ}_{0} \sqrt{{β}_{L}} , \qquad ( B20 )$$

where the first inequality follows from |dₖ|γ₀≤1. The last inequality follows from Lemma 2. Finally, Eq. (B20) implies that there must be some k for which

$$\vert {c}_{j}^{( k )} \vert \geq \frac{{γ}_{0} \sqrt{{β}_{L}}}{D} , or \vert {c}_{j}^{{( k )}^{2}} \vert \geq \frac{{γ}_{0}^{2} {β}_{L}}{{D}^{2}} .$$

### Lemma 4.

If M measurements from each |Ψₖ [symbol] are made, the probability of not obtaining 1 through L among the sampled bitstrings is bounded by

$${p}_{fail} \leq {L ( 1 - p )}^{M} \leq {Le}^{- Mp} . \qquad ( B21 )$$

Proof. The M measurements are independent, so the probability of not obtaining a particular bitstring |bⱼ [symbol] is (1−p)^{M}. The probability of not obtaining at least one of the L bitstrings follows from union bound.

### Lemma 5.

### Let

$$\vert ψ 〉 = \frac{1}{C} {\sum }_{j = 1}^{L} {c}_{j} \vert {b}_{j} 〉 ,$$

where

$$C = {( {\sum }_{j = 1}^{L} {\vert {c}_{j} \vert}^{2} )}^{1 / 2}$$

is the normalization constant. This state has energy close to the ground state energy, with difference bounded by

$$〈 \tilde{ψ} \vert H \vert \tilde{ψ} 〉 - 〈 {ψ}_{0} \vert H \vert {ψ}_{0} 〉 \leq 2 \sqrt{2} ‖ H ‖ {( 1 - \sqrt{{α}_{L}^{( 0 )}} )}^{1 / 2} . \qquad ( B22 )$$

Proof. First, we rewrite the error in energy. Let |φ [symbol] =|\tilde{ψ} [symbol] −|ψ₀ [symbol] . Then we get

$$〈 \tilde{ψ} \vert H \vert \tilde{ψ} 〉 - 〈 \vert {ψ}_{0} \vert H \vert {ψ}_{0} 〉 = 〈 \tilde{ψ} \vert H \vert ϕ 〉 + 〈 \vert ϕ \vert H \vert {ψ}_{0} 〉 = 2 Re ( 〈 \tilde{ψ} \vert H \vert ϕ 〉 ) . \qquad ( B23 )$$

Then we have

$$〈 \tilde{ψ} \vert H \vert \tilde{ψ} 〉 - 〈 {ψ}_{0} \vert H \vert {ψ}_{0} 〉 \leq 2 \vert 〈 ψ \vert H \vert ϕ 〉 \vert \leq 2 ‖ \vert ψ 〉 ‖ ‖ H \vert ϕ 〉 ‖ \leq 2 \cdot 1 \cdot ‖ H ‖ ‖ \vert ϕ 〉 ‖ . \qquad ( B24 )$$

where ∥H∥=supₓ∥H∥/∥x∥.

Finally, we calculate the norm difference as

$${‖ ψ 〉 - \vert {ψ}_{0} ‖}^{2} = {\sum }_{j = 1}^{L} {( \frac{1}{C} - 1 )}^{2} {\vert {c}_{j} \vert}^{2} + {\sum }_{L + 1}^{N} {\vert {c}_{j} \vert}^{2} = ( 1 - \frac{2}{C} + \frac{1}{{C}^{2}} ) {C}^{2} + ( 1 - {C}^{2} ) = 2 - 2 C . \qquad ( B25 )$$

and we can bound

$$C \geq \sqrt{{α}_{L}^{( 0 )}} , thus ‖ ψ 〉 - \vert {ψ}_{0} ‖ \leq \sqrt{2} {( 1 - \sqrt{{α}_{L}^{( 0 )}} )}^{1 / 2} .$$

### Proof for Theorem 2.

From Theorem 1, have a state |Ψ [symbol] with [symbol] Ψ|H|Ψ [symbol] − [symbol] ψ₀|H|ψ₀ [symbol] <ε with

$$ε = 8 Δ {E}_{N - 1} ( \frac{1 - {\vert {γ}_{0} \vert}^{2}}{{\vert {γ}_{0} \vert}^{2}} ) {( 1 + \frac{πΔ {E}_{1}}{Δ {E}_{N - 1}} )}^{- ( D - 1 )} . \qquad ( B26 )$$

### Let

$${ε}^{′} = \sqrt{1 - ε / Δ {E}_{1}} . \qquad ( B27 )$$

Then, from Lemma 1, get

$$‖ Ψ 〉 - \vert {ψ}_{0} ‖ < 2 - 2 {ε}^{′} . \qquad ( B28 )$$

Given |ψ₀ [symbol] is

$$( {α}_{L}^{( 0 )} , {β}_{L}^{( 0 )} )$$

-concentrated, then by Lemma 2, |Ψ [symbol] is (α_{L}, β_{L})-concentrated with parameters

$$\begin{matrix}{α}_{L} = {α}_{L}^{( 0 )} - 2 \sqrt{2 - 2 {ε}^{′}} & {β}_{L} = {β}_{L}^{( 0 )} - 2 \sqrt{2 - 2 {ε}^{′}}\end{matrix} \qquad ( B29 )$$

By Lemma 3, for each of the L concentrated bitstrings bⱼ with 1≤j≤L, able to sample bⱼ with probability at least

$$p = \frac{{γ}_{0}^{2}}{{( 2 d + 1 )}^{2}} ( {β}_{L}^{( 0 )} - 2 \sqrt{2 - 2 {ε}^{′}} ) \qquad ( B30 )$$

from at least one of the |Ψₖ [symbol] . Given M measurements, the probability of failing to sample bⱼ is at most (1−p)^{M}. Repeating this for each concentrated bitstring bⱼ, the probability of failing to sample all L bitstrings b₁ through b_{L} is

$${p}_{fail} \leq {L ( 1 - p )}^{M} \leq {Le}^{- {M}_{p}} = L exp ( - \frac{M {γ}_{0}^{2}}{{( 2 d + 1 )}^{2}} ( {β}_{L}^{( 0 )} - 2 \sqrt{2 - 2 \sqrt{1 - \frac{ε}{Δ {E}_{1}}}} ) ) \qquad ( B31 )$$

by union bound and by using p from Eq. (B30) and ε′ from Eq. (B27). If we succeed in sampling all L bitstrings, then the state [symbol] as defined in Lemma 5 exists in the sampled subspace, so the calculated energy will be bounded by

$$〈 \tilde{ψ} \vert H \vert \tilde{ψ} 〉 - 〈 {ψ}_{0} \vert H \vert {ψ}_{0} 〉 \leq 2 \sqrt{2} ‖ H ‖ {( 1 - \sqrt{{α}_{L}^{( 0 )}} )}^{1 / 2} , \qquad ( B32 )$$

which completes the proof of Theorem 2.

The description herein now briefly turns to a discussion of proving the sparsity of the ground state in the computational basis for a particular Hamiltonian. Consider the transverse field Ising model with periodic boundary conditions

$${H}_{n} ( h ) = - {\sum }_{i = 1}^{n} {Z}_{i} {Z}_{i + 1} - h {\sum }_{i = 1}^{n} {X}_{i} . \qquad ( C1 )$$

```
Theorem 3. If h - O((k/n)^{a}) for any a > 1/2, then the ground state of Hₙ(h) is fully supported on O(n^{k})
Z-basis states.
Proof. We will ignore the degeneracy of the ground state for simplicity, but the result holds without this
assumption by symmetry. Let |ψₙ(h) [symbol]   be the ground state of Hₙ(h). With this assumption, the ground state
is |ψₙ(0) [symbol]   = |00 ... 0 [symbol]   and lim_{h→∞} |ψₙ(h) [symbol]   = |++ ... + [symbol]  . Thus, intuitively, h controls the sparsity of the
ground state in the computational basis.
  Let |x| be the Hanmming weight of the bit string x, and define
${M}_{n} ( h ) = \frac{1}{n} {\sum }_{i = 1}^{n} 〈 {ψ}_{n} ( h ) \vert Z \text{?} \vert ψ \text{?} ( h ) 〉 \qquad ( C2 )$
$M ( h ) = {lim}_{n \to ∞} {M}_{n} ( h ) \qquad ( C3 )$
$\text{?} ( k , h ) = \text{?} {\vert 〈 x \vert {ψ}_{n} ( h ) 〉 \vert}^{2} \qquad ( C4 )$
${S}_{n} ( k , h ) = 1 - {\overline{S}}_{n} ( k , h ) . \qquad ( C5 )$
Sₙ(k, h) is a proxy for sparsity - it being small implies that there is very little weight on states outside of
$the d ‐ dimensional subspace defined by Hamming weight less than k , where d = {\sum }_{w = 0}^{k} ( \begin{matrix}n \\ w\end{matrix} ) .$
  $Define {a}_{x} by \vert {ψ}_{n} ( h ) 〉 = \sum \text{?} {a}_{x} \vert x 〉 . Furthermore , define {\overline{P}}_{n} ( w , h ) = {\sum }_{} \text{?} {\vert α \text{?} \vert}^{2} , so that$
${\overline{S}}_{n} ( k , h ) = {\sum }_{w = 0}^{k} {\overline{P}}_{n} ( w , h ) . Then$
${M}_{n} ( h ) = \frac{1}{n} {\sum }_{i = 1}^{n} {\sum }_{x , y ∈ {\{ 0 , 1 \}}^{n}} {\overline{α}}_{x} {α}_{y} 〈 x \vert Z \text{?} \vert y 〉 \qquad ( C6 )$
$= \frac{1}{n} {\sum }_{i = 0}^{n} {\sum }_{x ∈ {{\{ 0 , 1 \}}^{n}}_{\vert x \vert = w}} {\vert {α}_{x} \vert}^{2} ( - 1 ) \text{?} \qquad ( C7 )$
$= \frac{1}{n} {\sum }_{w = 0}^{n} {\sum }_{x ∈ {{\{ 0 , 1 \}}^{n}}_{\vert x \vert = w}} {\vert {α}_{x} \vert}^{2} {\sum }_{i = 1}^{n} ( - 1 ) \text{?} \qquad ( C8 )$
$= \frac{1}{n} {\sum }_{w = 0}^{n} {\sum }_{x ∈ {{\{ 0 , 1 \}}^{n}}_{\vert x \vert = w}} {\vert {α}_{x} \vert}^{2} ( n - 2 w ) \qquad ( C9 )$
$= {\sum }_{w = 0}^{n} {\tilde{P}}_{n} ( w , h ) ( 1 - 2 w / n ) \qquad ( C10 )$
$= {\sum }_{w = 0}^{k} {\overline{P}}_{n} ( w , h ) ( 1 - 2 w / n ) + {\sum }_{w = k + 1}^{n} {\overline{P}}_{n} ( w , h ) ( 1 - 2 w / n ) \qquad ( C11 )$
$\leq {\overline{S}}_{n} ( k , h ) + {\sum }_{w = k + 1}^{n} {\overline{P}}_{n} ( w , h ) ( 1 - 2 w / n ) \qquad ( C12 )$
$\leq {\overline{S}}_{n} ( k , h ) + ( 1 - 2 ( k + 1 ) / n ) {\sum }_{w = k + 1}^{n} {\overline{P}}_{n} ( w , h ) \qquad ( C13 )$
$= {\overline{S}}_{n} ( k , h ) + ( 1 - 2 ( k + 1 ) / n ) {\sum }_{w = k + 1}^{n} {\overline{P}}_{n} ( w , h ) \qquad ( C14 )$
$= 1 - \frac{2 ( k + 1 )}{n} {S}_{n} ( k , h ) . \qquad ( C15 )$
It follows that
${S}_{n} ( k , h ) \leq min ( \frac{n ( 1 - {M}_{n} ( h ) )}{2 k + 2} , 1 ) . \qquad ( C16 )$
$\text{?} \text{indicates text missing or illegible when filed}$
```

If Sₙ(k, h)→0 as n→∞, then the subspace of Hamming weight≤k bitstrings is fully capturing the ground state. The dimension of this space is

$$d = {\sum }_{w = 0}^{k} ( \begin{matrix}n \\ w\end{matrix} ) ,$$

which is ˜n^{k} for constant k.
Eq. (C16) implies that if Mₙ(h)=1−O((k/n)^{a}) for any a>1, the ground state is fully supported on O(n^{k}) bitstrings (ie. if Mₙ(h)=1−O((k/n)^{a}) for a>1, then Sₙ(k,h) decays to zero with increasing n). From the phase diagram of the transverse field Ising model, it is known that M(h)=(1−h²)^{1/8} for 0≤h≤1, and Mₙ(h)=>M(h) converges continuously with n→∞. It follows that h²=O((k/n)^{a}) for a>1 suffices. Theorem 3 immediately follows.

### Corollary 1.

If h=O((n/k)^{a}) for any a>½, then the ground state of Hₙ(h) is fully supported on O(n^{k}) X-basis states.

Proof. Apply a Hadamard matrix on each qubit to get a transformed Hamiltonian

$${H}_{{n}^{′}} ( h ) = - {\sum }_{i = 1}^{n} {X}_{i} {X}_{i + 1} - h {\sum }_{i = 1}^{n} {Z}_{i} .$$

Then, by Theorem 3, the ground state of H_{n′}(h) is fully supported on O(n^{k}) X-basis states if 1/h=O((k/n)^{a}) for any a>½.
Theorem 3 proves that the ground state of the transverse field Ising model is sparse in a product state basis (the Z-basis) deep in the ordered phase. Meanwhile, Corollary 1 proves that the ground state is sparse in a product state basis (the X-basis) deep in the disordered phase.

According to an embodiment, a system can comprise a processor that executes computer executable components stored in memory. The computer executable components can comprise a reference component that selects reference state and applies time evolution with respect to a Hamiltonian for different times to prepare Krylov basis states on a quantum device; a base component that prepares the Krylov basis states to obtain a fixed number of samples by sampling from the prepared basis states to classically represent the original Hamiltonian; and a representation component that classically represents the original Hamiltonian in subspace generated by the fixed number of samples to diagonalize the Hamiltonian in a bitstring subspace to obtain an approximation of ground state energy of the original Hamiltonian. An advantage of this system is that it outperforms traditional Krylov quantum diagonalization in the presence of shot noise, making it well-suited for near-term quantum devices.

In one or more embodiments of the aforementioned system, the Hamiltonian is a general Hamiltonian H, wherein

$$H = {\sum }_{l} {c}_{l} {P}_{l} ,$$

and wherein cₗ are real numbers and Pₗ denotes n-qubit Pauli matrices. In addition, the reference state may be further defined as: |ψ_{ref} [symbol] , and the Krylov basis states may be further defined as |φⱼ [symbol] =exp(−ijδtH)|ψ_{ref} [symbol] , where j∈[−d, −d+1, . . . , d−1, d] takes D=2d+1 different values, wherein d is a positive integer, t is a real number, and i denotes the imaginary unit. The L number of samples can be obtained from each |φⱼ [symbol] by measuring a computational basis, and wherein L is an integer. In one or more embodiments, S denotes the subspace of the bitstrings such that

$${S = \{ \vert {b}_{i} 〉 \}}_{i = 1}^{LD} ,$$

and wherein bᵢ is an integer. In various embodiments, a new representation of H in the subspace S is obtained classically by invoking sparsity of Pauli operators Pₗ in computational basis, wherein the new representation of H is denoted as \tilde{H}, and wherein a ground state energy of is obtained by classical diagonalization which approximates the ground state energy of H.

It should be appreciated that the system described herein can facilitate approximating ground state energy of many-body systems by combining the quantum Krylov method and the sampling-based subspace diagonalization approach. Under the sparsity assumption for the ground state of H, it is possible to analytically bound the error in estimating the ground state energy using Krylov diagonalization via quantum unitary sampling approach. The proof requires access to a reference state that has a good overlap with the ground state. This approach is suitable for noisy quantum devices as one does not need to estimate the overlap between Krylov basis states or estimate the expectation values on a quantum computer. It is only necessary to sample from time evolved states. Furthermore, the approach has been numerically verified for a Hamiltonian for which guarantees can be provided for the sparsity of the ground state. The solution converges to the true ground state energy as the number of samples from each Krylov basis state increases.

The system described herein may be contrasted from the prior art in that it uses Krylov basis states to sample. This helps with the problem of coming up with a good ansatz for the ground state for sample-based subspace diagonalization approach. Moreover, the system does not require the overlap between Krylov states to be estimated on a quantum device directly which is challenging on noisy devices. Furthermore, the system makes it possible to analytically bound the error in approximating the ground state energy under the sparsity assumption for the true ground state.

The system described above presents several advantages over the prior art. First, the system is suitable for near-term quantum computers as one needs to only prepare Krylov basis states and sample from them in the computational basis. Additionally, Krylov basis states are easy to prepare as they require a reference state, time evolved with respect to the Hamiltonian for different times. Furthermore, direct estimation of the expectation value of H is not required which saves the cost of mitigating the effect of noise on quantum devices. Finally, classical diagonalization implicitly ignores bitstrings that do not belong to the ground state subspace. Because estimating ground state energy is critical for understanding chemical reactions, bonding, molecular structure, and many-body physics, these advantages are extremely valuable in the field.

One or more embodiments are now described with reference to the drawings, where like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

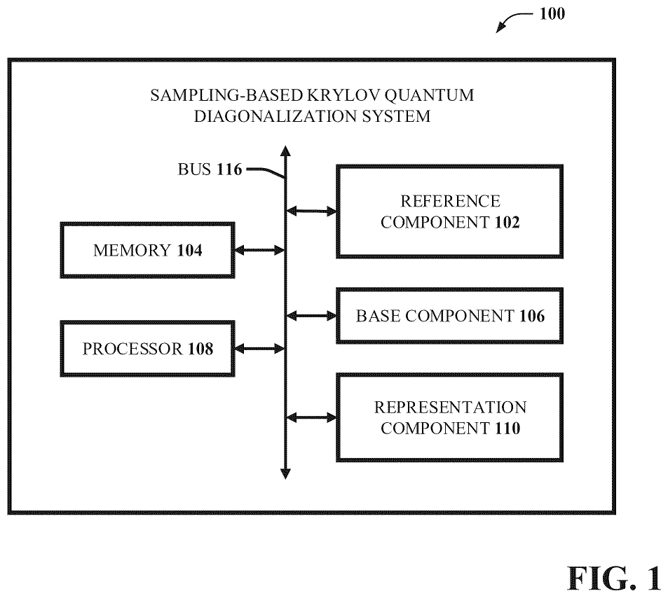

FIG. 1 illustrates block diagram of an example, non-limiting system 100 that can facilitate approximating ground state energy of many-body systems by, for example, combining the quantum Krylov method and the sampling-based subspace diagonalization approach. System 100 utilizes a reference component 102 that selects reference state and applies time evolution with respect to a Hamiltonian for different times to prepare Krylov basis states on a quantum device; a base component 106 that prepares the Krylov basis states to obtain a fixed number of samples by sampling from the prepared basis states to classically represent the original Hamiltonian; and a representation component 110 that classically represents the original Hamiltonian in subspace generated by the fixed number of samples to diagonalize the Hamiltonian in a bitstring subspace to obtain an approximation of ground state energy of the original Hamiltonian.

Aspects of systems, apparatuses or processes in various embodiments of the present invention can constitute one or more machine-executable components embodied within one or more machines (e.g., embodied in one or more computer readable mediums (or media) associated with one or more machines). Such components, when executed by one or more machines, e.g., computers, computing devices, virtual machines, etc. can cause the machines to perform the operations described. System 100 can comprise reference component 102, memory 104, base component 106, processor 108, representation component 110, and system bus 112.

The system 100 and/or the components of the system 100 can be employed to use hardware and/or software to solve problems that are highly technical in nature (e.g., related to approximating ground state energy of many-body systems, etc.), that are not abstract and that cannot be performed as a set of mental acts by a human. Further, some of the processes performed may be performed by specialized computers for carrying out defined tasks related to ground state energy approximation. The system 100 and/or components of the system can be employed to solve new problems that arise through advancements in technologies mentioned above and/or the like. System 100 can provide technical improvements to ground state energy approximation by outperforming traditional Krylov quantum diagonalization in the presence of shot noise, making it well-suited for near-term quantum devices.

Discussion turns briefly to processor 108, memory 104 and bus 112 of system 100. For example, in one or more embodiments, system 100 can comprise processor 108 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 108 to enable performance of one or more processes defined by such component(s) and/or instruction(s).

In one or more embodiments, system 100 can comprise a computer-readable memory (e.g., memory 104) that can be operably connected to the processor 108. Memory 104 can store computer-executable instructions that, upon execution by processor 108, can cause processor 108 and/or one or more other components of system 100 (e.g., reference component 102, base component 106, and/or representation component 110) to perform one or more actions. In one or more embodiments, memory 104 can store computer-executable components (reference component 102, base component 106, and/or representation component 110).

System 100 and/or a component thereof as described herein, can be communicatively, electrically, operatively, optically and/or otherwise coupled to one another via bus 112. Bus 112 can comprise one or more of a memory bus, memory controller, peripheral bus, external bus, local bus, and/or another type of bus that can employ one or more bus architectures. One or more of these examples of bus 112 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 108 and/or memory 104 described above, system 100 can comprise one or more computer and/or machine readable, writable and/or executable components and/or instructions that, when executed by processor 108, can enable performance of one or more operations defined by such component(s) and/or instruction(s).

In one or more embodiments of the aforementioned system, the Hamiltonian is a general Hamiltonian H, wherein

$$H = {\sum }_{l} {c}_{l} {P}_{l} .$$

In addition, the reference state may be further defined as: |ψ_{ref} [symbol] , and the Krylov basis states may be further defined as |φⱼ [symbol] =exp(−ijδtH)|ψ_{ref} [symbol] , where j∈[−d, −d+1, . . . , d−1, d] takes D=2d+1 different values, wherein d is a positive integer, t is a real number, and i denotes the imaginary unit. The L number of samples can be obtained from each |φⱼ [symbol] by measuring a computational basis, and wherein L is an integer. In one or more embodiments, S denotes the subspace of the bitstrings such that

$${S = \{ \vert {b}_{i} 〉 \}}_{i = 1}^{LD} ,$$

and wherein bᵢ is an integer. In various embodiments, a new representation of H in the subspace S is obtained classically by invoking sparsity of Pauli operators Pₗ in computational basis, wherein the new representation of H is denoted as \tilde{H}, and wherein a ground state energy of is obtained by classical diagonalization which approximates the ground state energy of H.

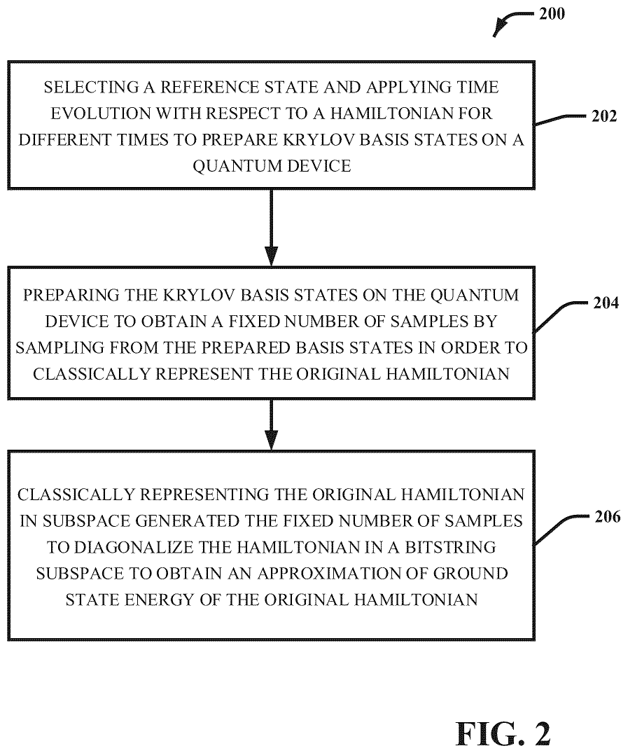

FIG. 2 illustrates a block diagram of an example, non-limiting method 200 that can facilitate approximating ground state energy of many-body systems by, for example, combining the quantum Krylov method and the sampling-based subspace diagonalization approach, and in accordance with one or more embodiments described herein, such as the non-limiting 100 of FIG. 1. While the non-limiting method 200 is described relative to the non-limiting system 100 of FIG. 1, the non-limiting method 200 can be applicable also to other systems described herein. Repetitive description of like elements and/or processes employed in respective embodiments is omitted for sake of brevity.

At 202, the method selects, by a system operatively coupled to the processor (e.g., reference component 102), a reference state and applying time evolution with respect to a Hamiltonian for different times to prepare Krylov basis states on a quantum device. At 204, the method prepares, by the system (e.g., base component 106), the Krylov basis states on the quantum device to obtain a fixed number of samples by sampling from the prepared basis states to classically represent the original Hamiltonian. At 206, the method classically represents, by the system, the original Hamiltonian in subspace generated by the fixed number of samples to diagonalize the Hamiltonian in a bitstring subspace to obtain an approximation of ground state energy of the original Hamiltonian.

Next, FIG. 3 illustrates an example, non-limiting comparison of SKQD and SQD methods, wherein |χ₀ [symbol] denotes the all-zero bitstring, D denotes the number of base states, and M denotes the number of samples from each base state. For the Hamiltonian H with h₁=h₂=0.1 and initial state χ₀=0ⁿ, the SKQD approach achieves lower error compared to the standard KQD method. The KQD approach incorporates Gaussian noise with a standard deviation of

$$\frac{1}{\sqrt{M}} ,$$

where M=5000, while estimating matrix elements as defined in (A3). The SKQD approach is evaluated with varying numbers of samples measured per Krylov state, denoted by M, and the number of Krylov basis states is set to D=15. FIG. 3 demonstrates that SKQD outperforms the standard KQD approach across different numbers of quibits.

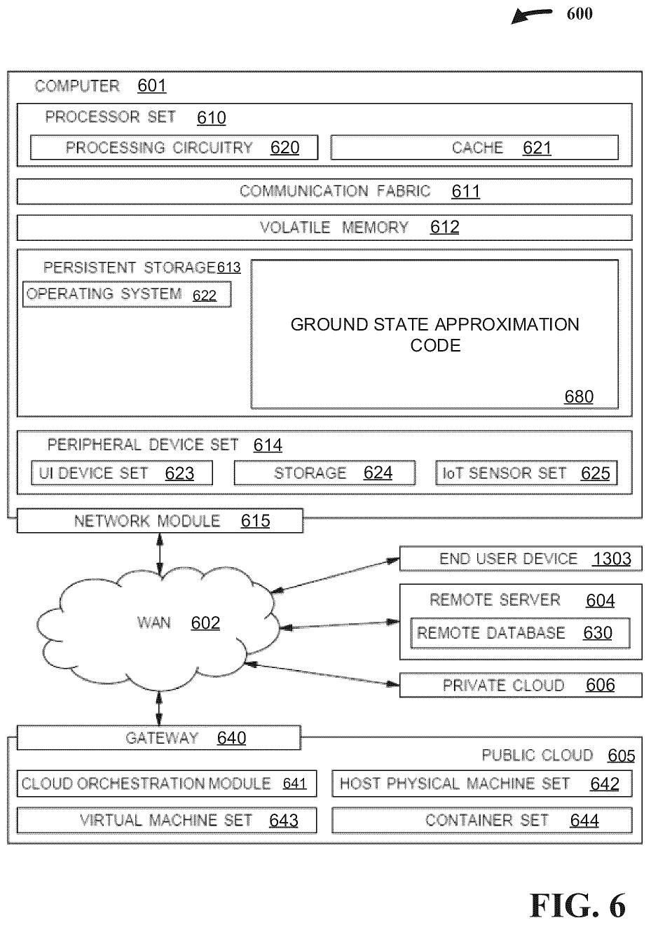

The illustrated embodiments described herein can be employed relative to distributed computing environments (e.g., cloud computing environments), such as described below with respect to FIG. 6, where certain tasks are performed by remote processing devices that are linked through a communications network. In a distributed computing environment, program modules can be located both in local and/or remote memory storage devices.

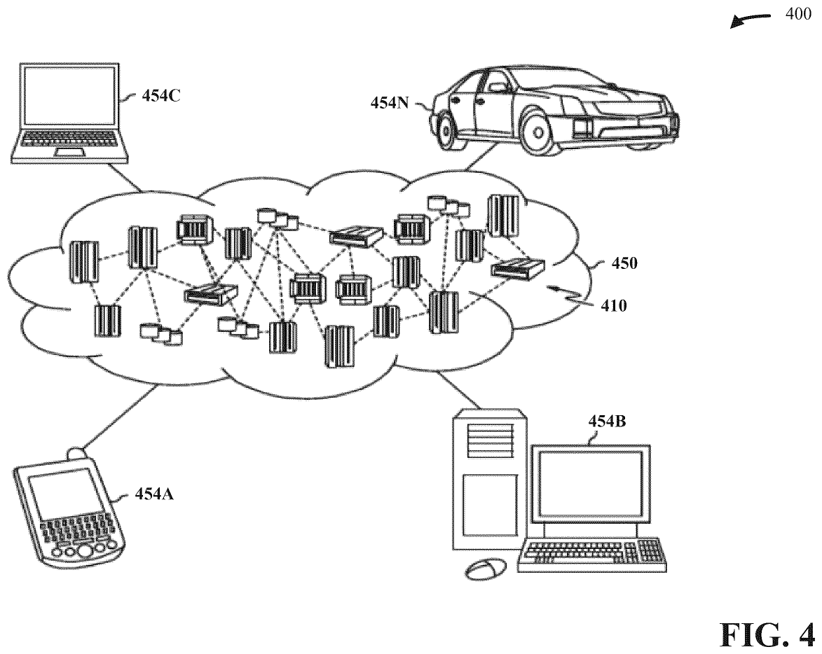

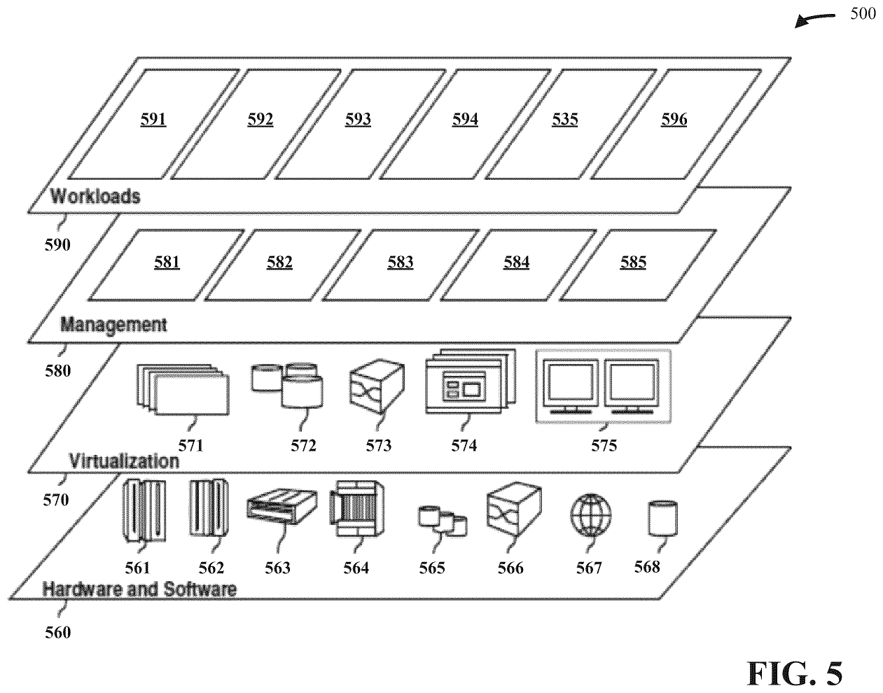

For example, one or more embodiments described herein and/or one or more components thereof can employ one or more computing resources of the cloud computing environment 450 described below with reference to illustration 400 of FIG. 4, and/or with reference to the one or more functional abstraction layers (e.g., quantum software and/or the like) described below with reference to FIG. 5, to execute one or more operations in accordance with one or more embodiments described herein. For example, cloud computing environment 450 and/or one or more of the functional abstraction layers 560, 570, 580 and/or 590 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by one or more embodiments described herein and/or components thereof to execute one or more operations in accordance with one or more embodiments described herein. For instance, one or more embodiments described herein and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and/or services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at one or more levels of abstraction appropriate to the type of service (e.g., storage, processing, bandwidth and/or active user accounts). Resource usage can be monitored, controlled and/or reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage and/or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems and/or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting system 100 and/or the example operating environment 800 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting system 100 and/or example operating environment 800 can be employed to use hardware and/or software to solve problems that are highly technical in nature, that are not abstract and/or that cannot be performed as a set of mental acts by a human.

Referring now to details of one or more aspects illustrated at FIG. 4, the illustrative cloud computing environment 450 is depicted. As shown, cloud computing environment 450 includes one or more cloud computing nodes 410 with which local computing devices used by cloud consumers, such as, for example, personal digital assistant (PDA) or cellular telephone 454A, desktop computer 454B, laptop computer 454C and/or automobile computer system 454N can communicate. Although not illustrated in FIG. 4, cloud computing nodes 410 can further comprise a quantum platform (e.g., quantum computer, quantum hardware, quantum software and/or the like) with which local computing devices used by cloud consumers can communicate. Cloud computing nodes 410 can communicate with one another. They can be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that cloud computing nodes 410 and cloud computing environment 450 can communicate with any type of computerized device over any type of network and/or network addressable connection (e.g., using a web browser).

Referring now to details of one or more aspects illustrated at FIG. 5, a set 500 of functional abstraction layers is shown, such as provided by cloud computing environment 450 (FIG. 4). One or more embodiments described herein can be associated with, such as accessible via, one or more functional abstraction layers described below with reference to FIG. 5 (e.g., hardware and software layer 560, virtualization layer 570, management layer 580 and/or workloads layer 590). It should be understood in advance that the components, layers and/or functions shown in FIG. 5 are intended to be illustrative only and embodiments described herein are not limited thereto. As depicted, the following layers and/or corresponding functions are provided:

Hardware and software layer 560 can include hardware and software components. Examples of hardware components include mainframes 561; RISC (Reduced Instruction Set Computer) architecture-based servers 562; servers 563; blade servers 564; storage devices 565; and/or networks and/or networking components 566. In one or more embodiments, software components can include network application server software 567, quantum platform routing software 568; and/or quantum software (not illustrated in FIG. 5).

Virtualization layer 570 can provide an abstraction layer from which the following examples of virtual entities can be provided: virtual servers 571; virtual storage 572; virtual networks 573, including virtual private networks; virtual applications and/or operating systems 574; and/or virtual clients 575.

In one example, management layer 580 can provide the functions described below. Resource provisioning 581 can provide dynamic procurement of computing resources and other resources that can be utilized to perform tasks within the cloud computing environment. Metering and Pricing 582 can provide cost tracking as resources are utilized within the cloud computing environment, and/or billing and/or invoicing for consumption of these resources. In one example, these resources can include one or more application software licenses. Security can provide identity verification for cloud consumers and/or tasks, as well as protection for data and/or other resources. User (or entity) portal 583 can provide access to the cloud computing environment for consumers and system administrators. Service level management 584 can provide cloud computing resource allocation and/or management such that required service levels are met. Service Level Agreement (SLA) planning and fulfillment 585 can provide pre-arrangement for, and procurement of, cloud computing resources for which a future requirement is anticipated in accordance with an SLA.

Workloads layer 590 can provide examples of functionality for which the cloud computing environment can be utilized. Non-limiting examples of workloads and functions which can be provided from this layer include mapping and navigation 591; software development and lifecycle management 592; virtual classroom education delivery 593; data analytics processing 594; transaction processing 595; and/or application transformation software 596.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

FIG. 6 and the following discussion are intended to provide a brief, general description of a suitable computing environment 600 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as classically representing the original Hamiltonian in subspace generated by a fixed number of samples to diagonalize the Hamiltonian in a bitstring subspace to obtain an approximation of ground state energy of the original Hamiltonian with ground state approximation code 680. In addition to block 680, computing environment 600 includes, for example, computer 601, wide area network (WAN) 602, end user device (EUD) 603, remote server 604, public cloud 605, and private cloud 606. In this embodiment, computer 601 includes processor set 614 (including processing circuitry 620 and cache 621), communication fabric 611, volatile memory 612, persistent storage 613 (including operating system 622 and block 645, as identified above), peripheral device set 614 (including user interface (UI), device set 623, storage 624, and Internet of Things (IOT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method can be distributed among multiple computers and/or between multiple locations. On the other hand, in this presentation of computing environment 600, detailed discussion is focused on a single computer, specifically computer 601, to keep the presentation as simple as possible. Computer 601 can be located in a cloud, even though it is not shown in a cloud in FIG. 6. On the other hand, computer 601 is not required to be in a cloud except to any extent as can be affirmatively indicated.

PROCESSOR SET 610 includes one, or more, computer processors of any type now known or to be developed in the future. Processing circuitry 620 can be distributed over multiple packages, for example, multiple, coordinated integrated circuit chips. Processing circuitry 620 can implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set can be located “off chip.” In some computing environments, processor set 610 can be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods can be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory can be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 can be a read only memory (ROM), but typically at least a portion of the persistent storage allows writing of data, deletion of data and re-writing of data. Some familiar forms of persistent storage include magnetic disks and solid-state storage devices. Operating system 622 can take several forms, such as various known proprietary operating systems or open-source Portable Operating System Interface type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 can include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 can be persistent and/or volatile. In some embodiments, storage 624 can take the form of a quantum computing storage device for storing data in the form of qubits. In embodiments where computer 601 is required to have a large amount of storage (for example, where computer 601 locally stores and manages a large database) then this storage can be provided by peripheral storage devices designed for storing large amounts of data, such as a storage area network (SAN) that is shared by multiple, geographically distributed computers. IoT sensor set 625 is made up of sensors that can be used in Internet of Things applications. For example, one sensor can be a thermometer, and another sensor can be a motion detector.

NETWORK MODULE 615 is the collection of computer software, hardware, and firmware that allows computer 601 to communicate with other computers through WAN 602. Network module 615 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and can take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 can be a client device, such as thin client, heavy client, mainframe computer and/or desktop computer.

REMOTE SERVER 604 is any computer system that serves at least some data and/or functionality to computer 601. Remote server 604 can be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data can be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs can be stored as images and can be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware and firmware allowing public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a reference component that selects reference state and applies time evolution with respect to a Hamiltonian for different times to prepare Krylov basis states on a quantum device;
a base component that prepares the Krylov basis states to obtain a fixed number of samples by sampling from the prepared basis states to classically represent the original Hamiltonian; and
a representation component that classically represents the original Hamiltonian in subspace generated by the fixed number of samples to diagonalize the Hamiltonian in a bitstring subspace to obtain an approximation of ground state energy of the original Hamiltonian.

2. The system of claim 1, wherein the Hamiltonian is a general Hamiltonian H, wherein
$$H = {\sum }_{l} {c}_{l} {P}_{l} ,$$
and wherein cₗ are real numbers and Pₗ denotes n-qubit Pauli matrices.

3. The system of claim 1, wherein the reference state is further defined as: |ψ_{ref} [symbol] .

4. The system of claim 3, wherein the Krylov basis states are further defined as |φⱼ [symbol] =exp(−ijδtH)|ψ_{ref} [symbol] , where j∈[−d, −d+1, . . . , d−1, d] takes D=2d+1 different values, and wherein d is a positive integer, t is a real number, and i denotes the imaginary unit.

5. The system of claim 4, wherein L number of samples are obtained from each |φⱼ [symbol] by measuring a computational basis, and wherein L is an integer.

6. The system of claim 2, wherein S denotes the subspace of the bitstrings such that
$${S = \{ \vert {b}_{i} 〉 \}}_{i = 1}^{LD} ,$$
and wherein bᵢ is an integer.

7. The system of claim 6, wherein a new representation of H in the subspace S is obtained classically by invoking sparsity of Pauli operators Pₗ in computational basis.

8. The system of claim 7, wherein the new representation of H is denoted as \tilde{H}.

9. The system of claim 8, wherein a ground state energy of \tilde{H} is obtained by classical diagonalization which approximates the ground state energy of H.

10. A computer-implemented method that utilizes a processor that executes computer executable components stored in memory to perform the following acts:
selecting a reference state and applying time evolution with respect to a Hamiltonian for different times to prepare Krylov basis states on a quantum device;
preparing the Krylov basis states on the quantum device to obtain a fixed number of samples by sampling from the prepared basis states in order to classically represent the original Hamiltonian; and
classically representing the original Hamiltonian in subspace generated by the fixed number of samples to diagonalize the Hamiltonian in a bitstring subspace to obtain an approximation of ground state energy of the original Hamiltonian.

11. The method of claim 10, wherein the Hamiltonian is a general Hamiltonian H, wherein
$$H = {\sum }_{l} {c}_{l} {P}_{l} ,$$
and wherein cₗ are real numbers and Pₗ denotes n-qubit Pauli matrices.

12. The method of claim 11, wherein the reference state is further defined as: |ψ_{ref} [symbol] .

13. The method of claim 12, wherein the Krylov basis states are further defined as |φⱼ [symbol] =exp(−ijδtH)|ψ_{ref} [symbol] , where j∈[−d, −d+1, . . . , d−1, d] takes D=2d+1 different values, and wherein d is a positive integer, t is a real number, and i denotes the imaginary unit.

14. The method of claim 13, wherein L number of samples are obtained from each |φⱼ [symbol] by measuring a computational basis, and wherein L is an integer.

15. The method of claim 12, wherein S denotes the subspace of the bitstrings such that
$${S = \{ \vert {b}_{i} 〉 \}}_{i = 1}^{LD} ,$$
and wherein bᵢ is an integer.

16. The method of claim 15, wherein a new representation of H in the subspace S is obtained classically by invoking the sparsity of Pauli operators Pₗ in the computational basis.

17. The method of claim 16, wherein the new representation of H is denoted as \tilde{H}.

18. The method of claim 17, wherein a ground state energy of \tilde{H} is obtained by classical diagonalization which approximates the ground state energy of H.

19. A computer program product comprising a computer readable storage medium having program instructions embodied therewith, the program instructions executable by a processor to cause the processor to:
select a reference state and apply time evolution with respect to the Hamiltonian for different times in order to prepare Krylov basis states on a quantum device;
prepare the Krylov basis states on the quantum device to obtain a fixed number of samples by sampling from the prepared basis states to classically represent the original Hamiltonian; and
classically represent the original Hamiltonian in subspace generated by the samples to diagonalize the Hamiltonian in a bitstring subspace to obtain an approximation of ground state energy of the original Hamiltonian.

20. The computer program product of claim 19, wherein the Hamiltonian is a general Hamiltonian H, and wherein
$$H = {\sum }_{l} {c}_{l} {P}_{l} ,$$
and wherein cₗ are real numbers and Pₗ denotes n-qubit Pauli matrices.
